(19) United States
(12) Patent Application Publication
(10) Pub. No.: US 2022/0381036 A1
(43) Pub. Date: Dec. 1, 2022

(54) Rubber Wheelchair Access Ramp

(71) Applicant: Envirorubber Solutions Pty Ltd, North Albury (AU)

(72) Inventor: Dale Suggate, North Albury (AU)

(21) Appl. No.: 17/520,166

(22) Filed: Nov. 5, 2021

(30) Foreign Application Priority Data
May 27, 2021 (AU) 2021901592

(51) Int. Cl. E04F 11/00; B05D 7/02; B05D 5/00; B05D 7/00

(52) U.S. Cl. CPC E04F 11/002; B05D 7/02; B05D 5/00; B05D 7/58

(57) ABSTRACT

A wheelchair access ramp suitable for wheelchair and pedestrian traffic includes a base layer adapted for placement of the access ramp, an adhesive layer applied to the base layer, the adhesive layer being effective in adhering to base layer, a grit material deposited across the adhesive layer to provide a slip-resistant surface, and a sealing layer applied across the slip-resistant surface providing a sealed slip-resistant surface exposed for wheelchair traffic across the access ramp.

### CROSS-REFERENCE TO RELATED APPLICATION

The present Application claims the benefit under 35 U.S.C. § 119 of Applicant's earlier filed Australian Provisional Patent Application No. 2021901592 filed on May 27, 2021. The contents of the specification accompanying the Applicant's prior application are to be considered incorporated herein by reference.

### BACKGROUND

### Technical Field

The present disclosure is broadly directed to a wheelchair access ramp and a method of forming a wheelchair access ramp. In particular, the present disclosure is directed to an access ramp including an exposed slip-resistant surface suitable for wheelchair and pedestrian traffic.

### SUMMARY

According to a first aspect of the present disclosure there is provided a wheelchair access ramp including a base layer adapted for placement of the access ramp, an adhesive layer applied to the base layer, the adhesive layer being effective in promoting adherence to the base layer, a grit material deposited across the adhesive layer to provide a slip-resistant surface, and a sealing layer applied across the slip-resistant surface providing a sealed slip-resistant surface exposed for wheelchair and pedestrian traffic across the access ramp.

In aspects, the adhesive layer may be a primer coating applied to the base layer. In certain aspects, the primer coating may be a water-based coating.

In other aspects, the base layer may be a composite mixture including rubber blended with polyurethane. In certain aspects, the rubber may include a combination of synthetic and natural rubbers such as that sourced from recycled tyres. In other aspects, the rubber may be in the form of crumbs or granules of a predetermined particle size distribution.

In aspects, the sealing layer may include a resinous material and is of a relatively low viscosity. In certain aspects, the low viscosity resinous sealing layer may be effective in keying to the slip-resistant surface including the grit material.

In other aspects, the grit material may be coupled to the base layer via the intermediate adhesive layer. In certain aspects, the grit material may be granular and may include natural or synthetic oxides, carbides, and silicates including but not limited to silicon dioxide in the form of quartz such as sand, aluminium oxides, silicon carbides, and silicates in the form of garnets.

In accordance with another aspect of the present disclosure there is provided a method of forming a wheelchair access ramp, the method including applying an adhesive layer to a base layer, the adhesive layer being effective in adhering to the base layer, depositing a grit material across the adhesive layer to provide a slip-resistant surface, and applying a sealing layer across the slip-resistant surface to provide a sealed slip-resistant surface exposed for wheelchair and pedestrian traffic across the access ramp.

### BRIEF DESCRIPTION OF THE DRAWINGS

In order to achieve a better understanding of the nature of the present disclosure a preferred embodiment of a wheelchair access ramp together with a method of forming a wheelchair access ramp will now be described, by way of example only, with reference to the accompanying illustrations in which:

FIG. 1 is an isometric view of part of a wheelchair access ramp according to an aspect of the present disclosure shown in part cutaway; and

FIG. 2 is an enlarged view of the area of detail indicated in FIG. 1.

### DETAILED DESCRIPTION

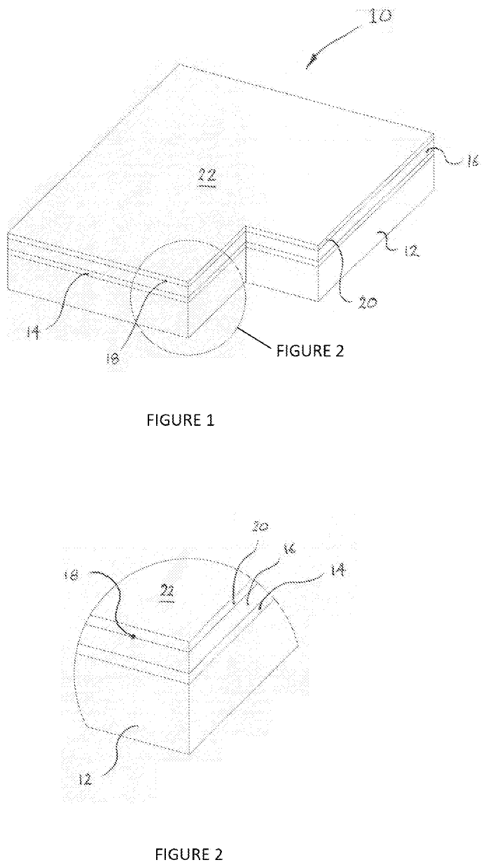

As shown in FIGS. 1 and 2, there is a wheelchair access ramp 10 shown in part and being suitable for wheelchair and more generally pedestrian traffic. Although the access ramp 10 is illustrated in part only, it will be appreciated that the access ramp 10 is otherwise shaped and sized in a conventional manner typically complying with regulatory Standards directed to wheelchair ramps and wedges designed to accommodate wheelchairs, walking frames, motorised scooters, and pedestrian traffic.

In this embodiment, the wheelchair access ramp 10 generally comprises:
1. a base layer 12 adapted for placement of the access ramp 10;
2. an adhesive layer 14 applied to the base layer 12, the adhesive layer 14 being effective in adhering to base layer 12;
3. a grit material schematically designed at 16 deposited across the adhesive layer 14 to provide a slip-resistant surface designated generally at 18;
4. a sealing layer 20 applied across the slip-resistant surface 18 providing a sealed slip-resistant surface 22 exposed for wheelchair traffic across the access ramp 10.

In this embodiment the adhesive layer 14 is a primer coating applied to the base layer 12. The primer coating 14 is typically a water-based coating which functions to promote adherence or coupling of the grit material 16 to the base layer 12.

The base layer 12 of this embodiment is a composite mixture including rubber blended with polyurethane. The rubber is typically in the form of rubber crumbs or granules of a predetermined particle size distribution. The rubber crumbs are derived from recycled tyres and as such include a combination of synthetic rubbers and natural rubbers. The rubber granules may be obtained from buffing material from tyre buffing.

The base layer 12 of this embodiment makes the largest contribution to the bulk of the access ramp 10. The base layer 12 is of a relatively dense construction having a typically density of around 830 kg/m³. This means the access ramps such as 10 are relatively heavy and as such generally do not require mechanical anchorage for secure placement in temporary or permanent installations. The relatively heavyweight access ramps such as 10 can nonetheless be moved with relative ease, for example to place in storage when not in use.

The sealing layer 20 may include a resinous material and is of a relatively low viscosity. In this example the resinous sealing layer 20 being of a low viscosity has the capability to flow for both (i) sealing of the slip-resistant surface 18, and (ii) keying with the grit material 16 in providing the sealed slip-resistant surface 22. The sealed slip-resistant surface 22 thus provides slip-resistant properties complying with the relevant regulatory Australian and/or New Zealand Standards providing access ramps such as 10 with improved stability and weather resistance. Samples of the slip-resistant surface 22 when tested using Slider 96 under the relevant Australian Standard exhibit a mean Slip Resistance Value (SRV) measured in accordance with the British Pendulum Number (BPN) of around 58 with a spread of SRVs between 55 and 60. It will be understood that these SRVs achieve a slip rating of P5 being the highest possible rating.

In this embodiment the grit material 16 is granular and includes natural or synthetic oxides, carbides, and silicates. The grit material may be sourced or derived from sand wherein it is in the form of silicone dioxide or naturally occurring quartz. The grit material also extends to synthetic oxides and carbides such as those adopted in other applications requiring slip-resistant properties where for example aluminium oxides and silicon carbides are used.

In a further embodiment, there is a method of forming a wheelchair access ramp such as 10. In the context of the access ramp 10 of the preceding embodiment this method broadly performs the steps of:
1. applying an adhesive layer 14 to a base layer 12, said adhesive layer 14 being effective in promoting adherence to the base layer 12;
2. depositing a grit material 16 across the adhesive layer 14 to provide a slip-resistant surface 18;
3. applying a sealing layer 20 across the slip-resistant surface 18 to provide a sealed slip-resistant surface 22 exposed for wheelchair and pedestrian traffic across the access ramp 10.

In embodiments, the method initially comprises moulding or otherwise fabricating the base layer 12 from a composite mixture including rubber crumbs blended with polyurethane. The moulded base layer 12 typically includes rubber crumbs derived from recycled rubber such as recycled tyres.

The method of this embodiment may involve:
1. applying the adhesive layer 14 to the base layer 12 by spraying the primer coating of the preferred embodiment across the base layer 12 in a relatively medium thickness film;
2. depositing the grit material 16 across the adhesive layer 14 via a vibratory sieve or other screen;
3. applying the sealing layer 20 across the slip-resistant surface 18 by spraying the resinous sealing material of the preferred embodiment across the slip-resistant surface 18 to provide the sealed slip-resistant surface 22.

In view of the embodiments described herein, it will be apparent to those skilled in the art that the wheelchair access ramp has at least the following advantages:
1. the access ramp effectively bonds its various layers providing a robust structure less likely to delaminate or breakdown over time;
2. the access ramps comply with the slip resistant or non-slip properties prescribed by the relevant regulatory Standards;
3. the access ramp at least in its preferred form is constructed largely from recycled products;
4. the access ramps lend themselves to both temporary and permanent installations whilst remaining in place with reduced risk of movement;
5. the access ramps can be custom manufactured in relatively large volumes adopting production techniques in the preferred method of manufacture.

Those skilled in the art will appreciate that the embodiments of the present disclosure are susceptible to variations and modifications other than those specifically described. For example, the materials from which the various layers are constructed may depart from the described embodiments provided they remain broadly within the defined aspects of the disclosure. The grit material may include silicates in the form of garnets and the grit material may be a mixture of any combination of the grit materials disclosed. The layers may be constructed from different manufacturing methods which depart from the embodiments described herein but nonetheless remain within the ambit of the disclosure. For example, the grit material and sealing layer may be applied simultaneously to the adhesive layer rather than separate application of these products as described in the present disclosure. It will be appreciated that the general profile and sectional shape of the access ramp may vary depending on its application as well as the relative thickness of each layer where for example the base layer may be tapered. The present disclosure is not limited to access ramps but may also extend to surface matting.

All such variations and modifications are to be considered within the scope of the present disclosure the nature of which is to be determined from the foregoing description.

What is claimed is:

1. A wheelchair access ramp, comprising:
a base layer adapted for placement of the access ramp;
an adhesive layer applied to the base layer, the adhesive layer being effective in promoting adherence to the base layer;
a grit material deposited across the adhesive layer to provide a slip-resistant surface; and
a sealing layer applied across the slip-resistant surface providing a sealed slip-resistant surface exposed for wheelchair and pedestrian traffic across the access ramp.

2. The wheelchair access ramp according to claim 1, wherein the adhesive layer is a primer coating applied to the base layer.

3. The wheelchair access ramp according to claim 2, wherein the primer coating is a water-based coating.

4. The wheelchair access ramp according to claim 1, wherein the base layer is a composite mixture including rubber blended with polyurethane.

5. The wheelchair access ramp according to claim 4, wherein the rubber includes a combination of synthetic and natural rubbers such as that sourced from recycled tyres.

6. The wheelchair access ramp according to claim 5, wherein the rubber is in the form of crumbs or granules of a predetermined particle size distribution.

7. The wheelchair access ramp according to claim 1, wherein the sealing layer includes a resinous material and is of a relatively low viscosity.

8. The wheelchair access ramp according to claim 7, wherein the low viscosity resinous sealing layer is effective in keying to the slip-resistant surface including the grit material.

9. The wheelchair access ramp according to claim 1, wherein the grit material is coupled to the base layer via the intermediate adhesive layer.

10. The wheelchair access ramp according to claim 9, wherein the grit material is granular and includes natural or synthetic material selected from the group consisting of oxides, carbides, and silicates.

11. The wheelchair access ramp according to claim 10, wherein the natural or synthetic material is a silicon dioxide selected from the group consisting of quartz, aluminium oxides, silicon carbides, and silicates in the form of garnets.

12. A method of forming a wheelchair access ramp, the method comprising:
applying an adhesive layer to a base layer, the adhesive layer being effective in adhering to the base layer;
depositing a grit material across the adhesive layer to provide a slip-resistant surface; and
applying a sealing layer across the slip-resistant surface to provide a sealed slip-resistant surface exposed for wheelchair and pedestrian traffic across the access ramp.
